(19) United States
(12) Patent Application Publication
(10) Pub. No.: US 2024/0052804 A1
(43) Pub. Date: Feb. 15, 2024

(54) KALMAN FILTER AND DEEP REINFORCEMENT LEARNING BASED WIND TURBINE YAW MISALIGNMENT CONTROL METHOD

(71) Applicant: Inwoo Chung, Daejeon (KR)

(72) Inventor: Inwoo Chung, Daejeon (KR)

(21) Appl. No.: 18/266,835

(22) PCT Filed: Dec. 29, 2021
(86) PCT No.: PCT/KR2021/020228

§ 371 Date: Jun. 13, 2023

(30) Foreign Application Priority Data
Dec. 30, 2020 (KR) 10-2020-0186882

(51) Int. Cl. F03D 7/04

(52) U.S. Cl. CPC F03D 7/046; F05B 2270/709; F05B 2270/329

(57) ABSTRACT

A Kalman filter and deep reinforcement learning based yaw misalignment control method of wind turbines is disclosed. During the normal operation of a wind turbine, the yaw misalignment control method of the present invention calculates non-stationary assembly angles by applying a Kalman filter to a series of really measured relative wind direction values and predicts non-stationary flow deflection angles through an actor-critic flow deflection angle prediction deep reinforcement learning model and then, by estimating and calibrating the yaw misalignment, the calibration of the yaw misalignment with the non-stationarity is completely automated, maximizing the reduction in operating costs for manual calibration of the non-stationarity of the yaw misalignment.

### TECHNICAL FIELD

The present invention relates to a yaw misalignment control method for maximizing wind turbine power production through a yaw misalignment calibration value prediction model based on the Kalman filter and deep reinforcement learning. Specifically, the present invention relates to a yaw misalignment control method to predict flow deflection angles caused by wake using free stream wind speeds and rotor rotation speeds received from a wind turbine through a Kalman filter and recurrent neural network based sequence flow deflection angle prediction model and to estimate and calibrate yaw misalignment with relative wind direction values obtained from wind turbine operation data, assembly angles calculated via the Kalman filter, and flow defection angles predicted by an actor-critic flow deflection angle prediction deep reinforcement learning model which is a self-learning model to maximize the power production of a wind turbine, using produced power as a reward value during the normal operation of a wind turbine.

### BACKGROUND ART

In the case of a horizontal axis wind turbine generating output power by rotating the rotor to a direction facing the wind direction as shown in [FIG. 1], the nacelle must be rotated to the direction facing the wind direction to maximize power production. To rotate the nacelle in the direction facing the wind direction, these wind turbines have a yawing system that rotates the nacelle, a meteorological mast composed of a wind vane and an anemometer installed on the nacelle, and a yaw controller that controls the yawing system to calculate and calibrate yaw misalignment.

As shown in [FIG. 2], the yaw misalignment can be defined with the relative wind direction for the nacelle direction, the assembly angle of a wind vane or lidar, and the flow deflection angle caused by wake behind the rotor. Here, the relative wind direction can be measured directly from a wind vane, but a wind vane's assembly angle must be measured and corrected before a wind turbine is operated. The flow deflection angle must be calculated and corrected during the operation. To accurately calculate and correct a wind vane's assembly angle and the flow deflection angle in an existing method, a lidar that precisely measures a free wind direction and a free stream wind speed is installed on the ground. The assembly angle is measured and corrected before operation. A lidar is always installed on the nacelle to measure the relative wind direction without the flow deflection angle to calibrate the yaw misalignment during the operation.

[1] and [2] are relevant to a method to reduce the cost of installing and operating a nacelle-based lidar in all wind turbines by calibrating the yaw misalignment without the nacelle-based lidar during the operation after a relationship model between variables that affect the flow deflection angle and a relative wind direction variable by installing a lidar on the nacelle or the ground before operation. [1] calibrates the yaw misalignment by estimating a relative wind direction corrected for the flow deflection angle using a machine learning model as a relational model, and [2] calibrates the yaw misalignment by estimating the flow deflection angle using a statistical analysis-based relation model and correcting the flow deflection angle for a measured relative wind direction.

These methods assume that the assembly angle and the flow deflection angle are stationary over time. However, an actual assembly angle varies over time. The relationship characteristics between the rotor rotation speed and free wind speed which affect the flow deflection angle and the flow deflection angle, also change over time by the wake effect generated by other wind turbines in a wind farm. So, assembly angle and the flow deflection angle characteristics have non-stationarity that varies over time.

For this reason, conventional methods such as [1] and [2] can precisely calibrate the yaw misalignment using a machine learning-based yaw misalignment calibration model and a statistics-based yaw misalignment calibration model without utilizing a lidar. Still, there arises a problem that the assembly angle must be re-corrected each time due to the non-stationarity of the assembly angle and the flow deflection angle. A flow deflection angle correction relationship model must be re-developed and applied.

In addition, since the methods [1] and [2] are yaw misalignment calibration models based on the stationarity of the flow deflection angle, the yaw misalignment problem caused by the wake effect, which is a leading cause that affects the non-stationarity of the flow deflection angle, could not be solved.

### Technical Problem

Among components of the yaw misalignment of a horizontal axis wind turbine, the assembly angle and the flow deflection angle have the non-stationarity. When developing a yaw misalignment calibrating model without the premise of such the non-stationarity, there arises a problem of periodically developing and applying a new yaw misalignment calibrating model of wind turbines in a wind farm. There arises a problem that the wake effect that affects the non-stationarity of the flow deflection angle could not be corrected effectively. To solve this problem, a yaw misalignment calibrating model should be developed under the premise that the assembly angle and the flow deflection angle have the non-stationarity.

### Solution to Problem

A wind vane's measured relative wind direction values reflect the assembly angle and the flow deflection angle. Assuming that measured relative wind direction values follow the hidden Markov model, the Kalman filter can be applied to a series of measured relative wind direction values to calculate the assembly angle and the flow deflection angle having the non-stationarity. The main factors influencing the flow deflection angle are the free wind speed and rotor rotation speed when not affected by the wake effect. In this hidden Markov model, hereafter, measured relative wind direction values are referred to as observed relative wind direction values, and hereafter, relative wind direction values really measured in a wind vane are referred to as really measured relative wind direction values.

Here, via training a recurrent neural network sequence model where a current flow deflection angle calculated from a series of really measured relative wind direction values through the Kalman filter is used as a target feature, and a previous flow deflection angle, a current free wind speed, and a current rotor rotation speed are used as input features, it is possible to obtain a nonlinear relationship model between the free wind speed and rotor rotation speed and the flow deflection angle.

To train a Kalman filter and recurrent neural network based sequence flow deflection angle prediction model, when wind turbines in a wind farm are operated normally for a certain term, the average values of really measured relative wind direction values, free wind speeds, output power values, and rotor speeds and measurement times for a certain period are received from wind turbines and stored. Raw data is generated for training the sequence flow deflection angle prediction model.

The Kalman filter is applied to a series of really measured relative wind direction values for each wind turbine to obtain a series of the summed values of assembly angles and flow deflection angles, and the Kalman filter is applied to a series of really measured relative wind direction values to obtain a series of assembly angles. A series of the summed values of assembly angles and flow deflection angles is subtracted by a series of assembly angles to obtain a series of flow deflection angles for each wind turbine. Training data of a certain number of sequences is generated using previous flow deflection angles, current free wind speeds, and current rotor rotation speeds as input features, and current flow deflection angles as a target feature. Then, the recurrent neural network based sequence flow deflection angle prediction model is trained with the training data.

The recurrent neural network based sequence flow deflection angle prediction model is a relationship model under the premise that a sequence relationship between previous flow deflection angles, current free wind speeds, and current rotor rotation speeds and current flow deflection angles has stationarity. Therefore, it is impossible to predict flow deflection angles by reflecting the non-stationarity of the flow deflection angle using this model.

The recurrent neural network based sequence flow deflection angle prediction model is used as an actor in an actor-critic deep reinforcement learning model, and a recurrent neural network based sequence relationship model of free wind speeds, rotor rotation speeds, flow deflection angles, and differential action values is used as a critic. With an actor-critic flow deflection angle prediction deep reinforcement learning model using output power as a reward value, a relation model reflecting the non-stationarity of the sequence relationship of previous flow deflection angles, current free wind speeds, and current rotor rotation speeds and current flow deflection angles can be trained. Then it is possible to more accurately predict the flow deflection angle with the non-stationarity due to turbulence and the wake effect.

The weight data of a pre-trained recurrent neural network based sequence flow deflection angle prediction model is loaded as the actor's weight data of the actor-critic flow deflection angle prediction deep reinforcement learning model, so the actor-critic flow deflection angle prediction deep reinforcement learning model learns by itself and predicts the flow deflection angle with the non-stationarity while reliably predicting the flow deflection angle without initial reinforcement learning.

Yaw misalignment values are estimated by adding flow deflection angles predicted by the actor-critical flow deflection angle prediction deep reinforcement learning model with really measured relative wind direction values and assembly angles obtained by applying the Kalman filter to really measured relative wind direction values. The yaw misalignment is calibrated using estimated yaw misalignment values.

### Advantageous Effects of Invention

When calibrating the yaw misalignment of a wind turbine, assembly angles must be corrected at regular intervals, and a yaw misalignment estimation relationship model including the flow deflection angle must be re-analyzed or trained because of the non-stationarity of the assembly angle and the flow deflection angle of the yaw misalignment. In particular, periodic correction for the non-stationarity of the assembly angle and the flow deflection angle of many wind turbines in a wind farm incurs enormous costs. However, during the normal operation of a wind turbine, nonstationary assembly angles are calculated by applying the Kalman filter to a series of really measured relative wind direction values, and non-stationary flow deflection angles are calculated using the actor-critical flow deflection angle prediction deep reinforcement learning model. With the calculated assembly and flow deflection angles, it is possible to estimate and calibrate the yaw misalignment in real-time. That is, the calibration of the yaw misalignment of the non-stationarity is fully automated to maximize the reduction of the operating cost of the manual calibration for the nonstationary yaw misalignment.

The actor-critic flow deflection angle prediction deep reinforcement learning model, which applies the recurrent neural network based sequence flow deflection angle prediction model as the actor, automatically learns the flow deflection angle prediction model by itself using output power as a reward value during the normal operation of a wind turbine and then, predicts flow deflection angles. Through the yaw misalignment calibration that reflects the flow deflection angle's non-stationarity affected by turbulence and the wake effect that change in real-time, it is possible not only to calibrate the yaw misalignment more accurately than a calibration method that does not reflect the non-stationarity of the yaw misalignment but also to correct the wake effect being a significant factor reducing power generation for wind farm power generation and then, maximize the output power of a wind turbine itself and the power production of a wind farm.

### BRIEF DESCRIPTION OF DRAWINGS

FIG. 1 is a block diagram of components of a yaw control system of a horizontal axis wind turbine.

FIG. 2 is a schematic diagram of a yaw misalignment component.

FIG. 3 is a flowchart illustrating a method for controlling a yaw misalignment based on a Kalman filter and deep reinforcement learning according to an embodiment of the present invention.

FIG. 4 is a schematic diagram of a hidden Markov model of an observed relative wind direction.

FIG. 5 is a flowchart to calculate summed values of assembly angles and flow deflection angles or assembly angles from a series of really measured relative wind direction values using a Kalman filter according to an embodiment of the present invention.

FIG. 6 is a flowchart for calculating flow deflection angles using a Kalman filter according to an embodiment of the present invention.

FIG. 7 is a schematic diagram of a recurrent neural network based sequence flow deflection angle prediction model according to an embodiment of the present invention.

FIG. 8 is a block diagram of a self-learning yaw misalignment control intelligent entity according to an embodiment of the present invention.

FIG. 9 is a schematic diagram of an actor model according to an embodiment of the present invention.

### DESCRIPTION OF EMBODIMENTS

The present invention will be described using the accompanying drawings through the following contents by way of specific examples.

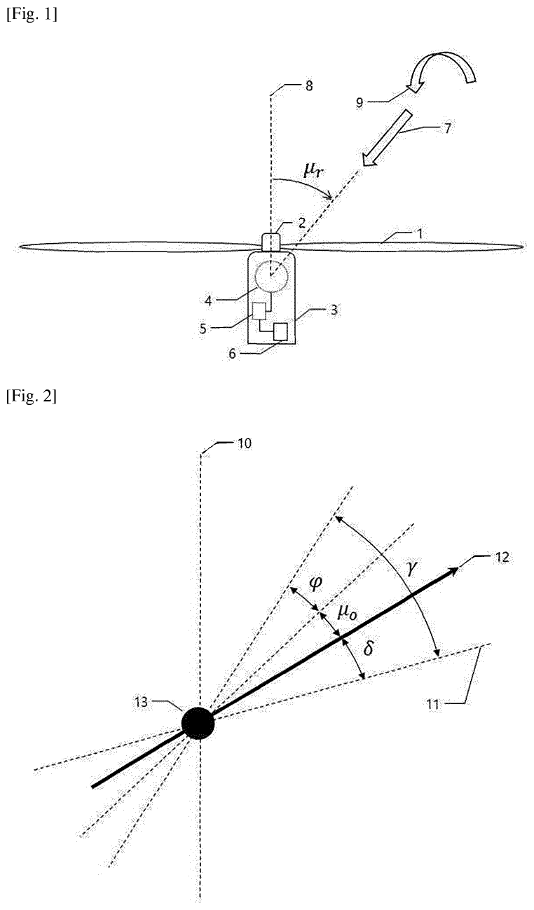

The present invention relates to a yaw misalignment calibration method of a horizontal axis wind turbine. As shown in [FIG. 1], the horizontal axis wind turbine is mainly composed of the blade (1), rotor (2), and nacelle (3), and since the horizontal axis wind turbine's output power efficiency decreases due to the misalignment of the nacelle direction (8) for the wind direction (7), the output power efficiency is increased by rotating the nacelle to align the nacelle direction with the wind direction as yaw controlling. Via yaw controlling, a relative wind direction is measured in the meteorological tower (6) installed in the nacelle. The yaw misalignment is estimated using relative wind direction values really measured in the yaw controller (5). The yawing system (4) is controlled to calibrate the yaw misalignment.

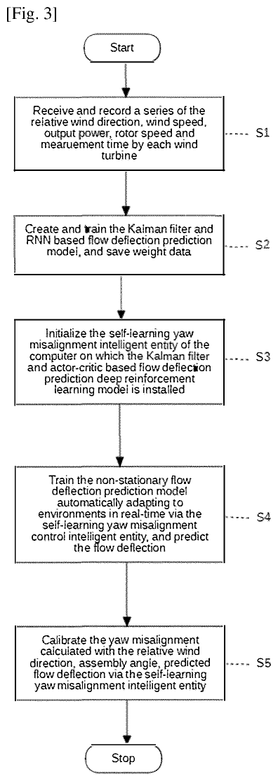

However, shown in FIG. 3, the relative wind direction really measured in a wind vane for the real relative wind direction (μᵣ) is distorted not only by the flow deflection angle (δ) incurred by the wind's blades passing and the assembly angle (φ) of a wind vane, but also in a measurement process by a sensor.

αₒ=g(−φ−δ+μᵣ) (1)

where μₒ are observed relative wind direction values in the hidden Markov model, g is a transformation function of a sensor. To calibrate the yaw misalignment from a distorted, observed relative wind direction values (μₒ), assembly angles (φ) and flow deflection angles (δ) are calculated, and then, as Equation 2, the yaw misalignment (γ) of the real relative wind direction should be estimated

γ=μᵣ=φ+δ+g⁻¹(μₒ) (2)

As shown in FIG. 3, to estimate and calibrate the yaw misalignment (γ) of the real relative wind direction (μᵣ), in step S1, a series of really measured relative wind direction values, free wind speeds, output power values, and rotor rotation speeds during the normal operation for each wind turbine in a wind farm are received and saved as operation data. In step S2, using the operation data as the training data of the Kalman filter and recurrent neural network based flow deflection angle prediction model, the recurrent neural network based sequence flow deflection angle prediction model is created and trained where current flow deflection angles calculated through the Kalman filter is used as a target feature, and previous flow deflection angles, free wind speeds, and rotor rotation speeds are used as input features. The weight of the recurrent neural network based sequence flow deflection angle prediction model is used as the pre-trained weight of the actor model of the actor-critic based flow deflection angle prediction deep reinforcement learning model. So, we store the weight data of a trained recurrent neural network based sequence flow deflection angle prediction model.

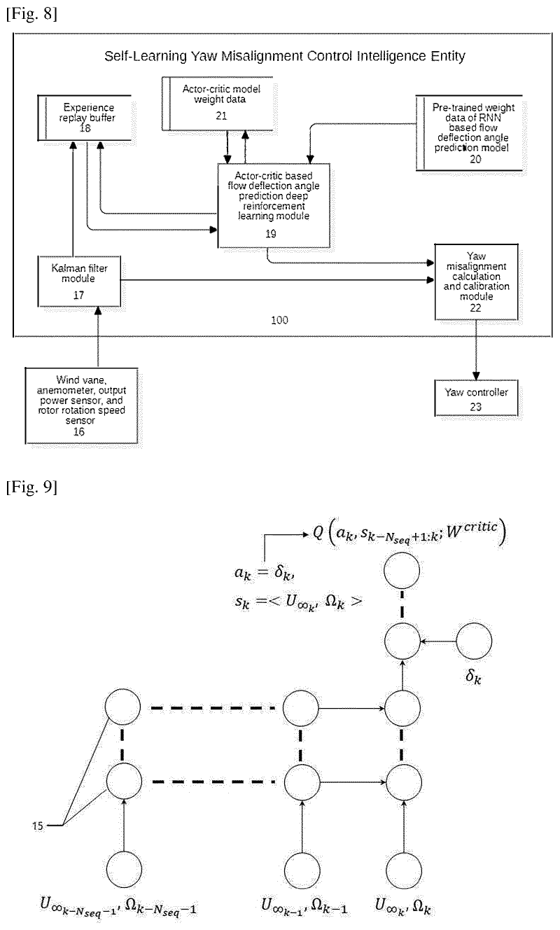

The yaw misalignment method through the Kalman filter and actor-critic based flow deflection angle prediction deep reinforcement learning, by itself, learns a yaw misalignment method to maximize power production in response to changes in the characteristics of factors that affect wind power during the operation of a wind turbine. It is an intelligent and automated method to calibrate the yaw misalignment. The system in which this method is implemented is a self-learning yaw misalignment control intelligent entity (100) equipped with intelligent software on a computer, as shown in [FIG. 8], and is installed to interlock with a control system in a wind turbine.

In step S3, after the self-learning yaw misalignment control intelligent entity (100) is installed in a wind turbine, before the first wind turbine operation, according to an operator's choice, the actor-critic flow deflection angle prediction deep reinforcement learning module (19) is initialized by loading the pre-trained recurrent neural network based sequence flow deflection angle prediction model weight data (20) as actor weight data and then, can be initialized by loading the pre-trained recurrent neural network based sequence flow deflection angle prediction model weight data (20) or by loading actor-critic model weight data trained while operating a wind turbine as the actor weight data, before a wind turbine is operated.

After starting the operation of a wind turbine in step S4, in the self-learning yaw misalignment control intelligent entity (100), the really measured relative wind direction, free wind speed, output power, and rotor rotation speed information is received from the wind vane, anemometer, output power sensor, and rotor rotation speed sensor (16) as an input signal, and the Kalman filter module (17) calculates assembly angles through the Kalman filter from a series of really measured relative wind direction values and averages really measured relative wind direction values, free wind speeds, rotor rotation speeds, and output power values over a certain period. The averaged values of the free wind speed, rotor rotation speed, and output power are sent and stored to the experience replay buffer (18). Really measured relative wind direction average values and assembly angle are sent to the yaw misalignment calculation and calibration module (22). The actor-critic flow deflection angle prediction deep reinforcement learning module (19) uses a previous flow deflection angle, a current free wind speed, a rotor rotation speed, a flow deflection angle, and a next output power value obtained from the experience replay buffer (18) as a unit experience feature. A series of experience feature sequences are randomly sampled to generate training data, and actor and critic models are trained to store the trained weight data (21) of the actor and critic models. After training, current flow deflection angles are predicted by using the sequence data of previous flow deflection angles, current free wind speeds, and rotor rotation speeds for a certain period. Current flow deflection angle values are sent and stored to the experience replay buffer (18) and sent to the yaw misalignment calculation and calibration module (22).

In step S5, a yaw misalignment calibration value is calculated using really measured relative wind direction average values, assembly angles, and current flow deflection angles received by the yaw misalignment calibration module (22), and the yaw misalignment calibration information is used as an output signal to calibrate the yaw misalignment in real-time.

Next, the S1 and S2 steps to train the Kalman filter and recurrent neural network based flow deflection angle prediction model and the S3, S4, S5 steps to learn the yaw misalignment calibration model by itself according to the situation of a wind turbine in real-time through the self-learning yaw misalignment control intelligent entity (100) will be described in more detail.

In step S1, a series of measurement time values and average values of really measured relative wind direction values (μ_{z}^{raw}), free wind speeds (U_{∞}^{raw}), output power values (P^{raw}), and rotor rotation speeds (Ω^{raw}) for a certain period (T^{raw}) within a certain term is obtained and stored during the normal operation by each wind turbine of a wind farm. Hereafter, the average value and the variance value over T^{raw} are called a raw average value and a variance value. Here, T^{raw} is greater than 0, an integer multiple of a unit time, T^{unit} and satisfies the following equation.

T^{raw}=R^{raw}T^{unit},R^{raw}ϵN

where N is an integer set. In step S2, to create and train the recurrent neural network based sequence flow deflection angle prediction model, a series of raw average values (μ_{z}^{raw}) of really measured relative wind direction values is used to calculate really measured relative wind direction values (μ_{z}^{1st}) averaged over T^{φ+δ} necessary to calculate the summed values of assembly angles and flow deflection angles, and to calculate really measured relative wind direction values (μ_{z}^{2nd}) averaged over T^{φ} necessary to calculate assembly angles. Hereafter, the average value and the variance value over T^{φ+δ} are called the first average value and the first variance value. The average value and the variance value over T^{φ} are called the second average value and the second variance value. A series of flow deflection angles is calculated by applying a series of the first and second average values of really measured relative wind direction values to Kalman filtering. Here, T^{φ+δ} [symbol] T^{φ} are greater than 0, an integer multiple of T^{raw} and satisfy the following equation.

$${T}^{φ + δ} = {R}^{φ + δ} {T}^{raw} , {R}^{φ + δ} ∈ N$$

$${T}^{φ} = {R}^{φ} {T}^{raw} , {R}^{φ} ∈ N$$

$${T}^{φ} / {T}^{φ + δ} = \frac{{R}^{φ} {T}^{raw}}{{R}^{φ + δ} {T}^{raw}} = \frac{{R}^{φ}}{{R}^{φ + δ}} = R ∈ N$$

where R^{φ+δ} is greater than 0, an integer multiple for T^{raw} to be T^{φ+δ}, R^{φ} is greater than 0, an integer multiple for T^{raw} to be T^{φ}, and R is greater than 0, an integer multiple as T^{φ} over T^{φ+δ}.

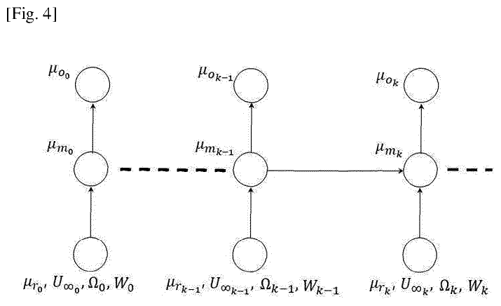

As shown in FIG. 4, a series of observed relative wind direction values (μₒ) can be defined with the hidden Markov model. For assembly angles and flow deflection angles to be approximately calculated using the Kalman filter based on this hidden Markov model, primarily, the summed values of current assembly angles and current flow deflection angles are calculated using the Kalman filter with the first average values of really measured relative wind direction values over T^{φ+δ} for the current real relative wind direction's average and variance values defined in the hidden Markov model to approximate 0 and a certain value respectively, as Equation (3). Current assembly angles are calculated using the Kalman filter with the second average values of really measured relative wind direction values over T^{φ} for the average and variance values of the summed values of current real relative wind directions and current flow deflection angles defined in the hidden Markov model to approximate 0 and a certain value respectively, as Equation (4). Flow deflection angles are approximately calculated by subtracting calculated assembly angles from calculated summed values of assembly angles and flow deflection angles.

μᵣ_{ₖ}˜N(0,σᵣ_{ₖ}²) (3)

μᵣ_{ₖ}−δₖ˜N(0,σ_{μ}_{ᵣ}_{-δ}_{ₖ}² (4)

where μᵣ_{ₖ} is a current real relative wind direction, μᵣ_{ₖ}_{-δ}_{ₖ} is a difference value between the real relative win direction and the current flow direction angle, σ_{μr}_{ₖ}²,

$$\\ {σ}_{{μ}_{{r}_{e}} - {δ}_{k}}^{2}$$

are the variance values of μᵣ_{ₖ}, μrₖ−δₖ over [symbol] T^{φ+δ},T^{φ} respectively.

Current observed relative wind direction values (μₒ_{ₖ}) are defined as Equation (5) on the premise that previous free wind speeds (U_{∞}_{ₖ}), previous rotor rotation speeds (Ωₖ₋₁), the previous wake effect (Wₖ₋₁)'s external effects, and previous real relative wind direction values (μᵣ_{ₖ}) satisfy the hidden Markov model.

μₒ_{ₖ}=fₖ^{μ}^{ᵣ}(μᵣ_{_{k−1}},U_{φ}_{_{k−1}},Ωₖ₋₁,Wₖ₋₁) (5)

Current assembly angles (φₖ) are defined as Equation (6) under the premise that the axis direction of a wind vane changes rapidly at random due to other causes or gradually changes (aging) over time, and current assembly angles satisfy the hidden Markov model.

φₖ=fₖ^{φ}(φₖ₋₁)+φₖ^{e}+ε_{φ}_{ₖ} (6)

where fₖ^{φ}(φₖ₋₁) is a current internal transformation function for the assembly angle and is approximated as a function for a monotonic function interval to change over time, and φₖ^{e} is an externally affected, current random variable of the assembly angle, and ε_{φ}_{ₖ} is a random variable with an average value of 0 and a certain variance value as the noise of the current assembly angle.

Current flow deflection angles (δₖ) also have non-stationarity due to the wake effect of other wind turbines in a wind farm and the turbulence (9) due to other causes and is defined as in Equation (7) on the premise that current flow deflection angles satisfy the hidden Markov model.

δₖ=fₖ^{δ}(Ωₖ₋₁)+βδₖ^{e}(U_{∞}_{ₖ},φₖ,Wₖ)+ε_{δ}_{ₖ} (7)

where fₖ^{δ}(δₖ₋₁) is a current internal transformation function for the flow deflection angle, and p is an externally affected coefficient of the flow deflection angle, and δₖ⁰(U_{∞}_{ₖ}, Ωₖ, Wₖ) is a function for the current free wind speed (U_{∞}_{ₖ}), current rotor rotation speed (Ωₖ), current wake effect (Wₖ) as an externally affected, current flow deflection angle, and ε_{δ}_{ₖ} is a random variable with an average value of 0 and a certain variance value as the noise of the current flow deflection angle.

So, current distorted relative wind direction values (μₘ_{ₖ}) before being measured by a sensor are defined as Equation (8), and relative wind directions after being measured by a sensor are defined as observed relative wind direction values, as in Equation (9).

μₘ_{ₖ}=−φₖ−δₖ+μᵣ_{ₖ} (8)

μₒ_{ₖ}=g(μₘ_{ₖ})+ε_{g}_{ₖ} (9)

ε_{g}_{ₖ} is a random variable with an average value of 0 and a certain variance value as the noise generated from a current sensor measurement.

To estimate real relative wind direction values more accurately using the Kalman filter under the premise that observed relative wind direction values satisfy the hidden Markov model as above, the internal transformation function, the external factor function, and the internal noise of Equations (5), (6), and (7) and the sensor conversion function and sensor noise of Equation (9) must be defined. However, it is very difficult to define each of these internal conversion functions, external factor functions and internal noise, sensor conversion functions, and sensor noise.

However, each internal transformation function is approximated as 1 of a continuous function, and external factor functions to satisfy each transformation of Equations (5), (6), (7) are approximated using a series of really measured relative wind direction values (μ_{z}) as followings. Then a Kalman filter model can be developed. A current external factor function (ξₖ) is the sum of a current external factor assembly angle function (φₖ^{e}) and a current external factor flow deflection angle function (δₖ^{e}) as Equation (10). Such the current external factor function (ξₖ) is approximated as the multiplication of the difference value of near average values (μ̅_̅{̅z̅}̅_̅{̅ₖ̅}̅) over T^{near} of really measured relative wind direction values (μ_{z}) and an external factor coefficient (σₖ) which is experimentally calculated as optimal values for the Kalman filter (K^{φ+δ}) to calculate the summed values of assembly angles and flow deflection angles and for the Kalman filter (K^{φ}) to calculate assembly angles, respectively and is applied to the calculation of the external factor function.

ξₖ=φ_{z}_{ₖ}^{e}+δ_{z}_{ₖ}^{e}=c_{ξ}×(μ̅_̅{̅z̅}̅_̅{̅ₖ̅}̅−μ̅_̅{̅z̅}̅_̅{̅_̅{̅k̅−̅1̅}̅}̅) (10)

where T^{near} is greater than 0, an integer multiple of T^{φ+δ} or T^{φ} and is defined by the following equation.

T^{near}=R^{near}T^{φ+δ} or T^{near}=R^{near}T^{φ},R^{near}ϵN

Since each internal noise is very small, they are approximated as values close to 0. A sensor transformation function is defined as a linear function with coefficients (α₁, α₂) as Equation (11) obtained as optimal values via Kalman filter tuning. Since the internal noise is close to 0, the average values of the near variance values of really measured relative wind direction values (μ_{z}) are used as the approximate values of the sensor noise.

h(μₘ_{ₖ})=α₁×μₘ_{ₖ}+α₂ (11)

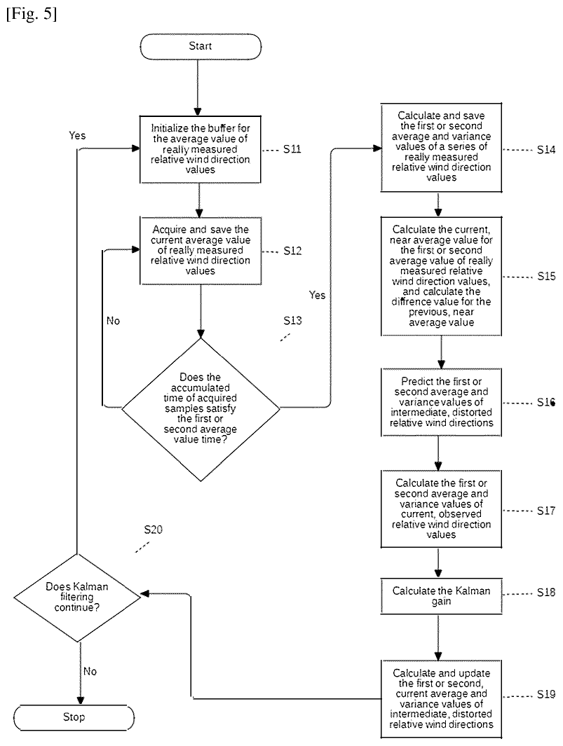

FIG. 5 is a flow chart for a specific method to calculate the summed values of assembly angles and flow deflection angles or assembly angles from a series of really measured relative wind direction values (μ_{z}) via the Kalman filter.

In step S11, a buffer for raw average values of really measured relative wind direction values is initialized. In step S12, current raw average values (μ_{z}_{ᵢ}^{raw}) of really measured relative wind direction values are acquired and saved to the buffer. In step S13, if the total integration time of the obtained raw average samples of really measured relative wind direction values satisfies T^{φ+δ} or T^{φ}, the S14 step is executed. Otherwise, the S12 step is executed. In step S14, the first or second average values of μ_{z}_{_{R}}_{^{φ+δ}}_{-t+1,R}_{^{α+δ}}^{raw} or μ_{z}_{_{R}}_{^{φ}}_{-t+1,R}_{^{φ}}^{raw} over T^{φ+δ} or T^{φ}, are calculated as current, really measured relative wind direction values (μ_{z}_{ₖ}), and the first or second variance values are calculated. In step S15, current near average values are calculated and stored using a series of the first or second really measured relative wind direction average values (μ_{z}_{_{R}}_{^{near}}_{-k+1,}k). The current external factor function (ξₖ) is calculated as a difference value between the current near average value (μ̅_̅{̅z̅}̅_̅{̅ₖ̅}̅) and the previous near average value (μ̅_̅{̅z̅}̅_̅{̅_̅{̅k̅−̅1̅}̅}̅) of really measured relative wind direction values, as Equation (10). In step 16, the first or second previous average values of distorted relative wind direction values and the current external factor function (ξₖ) are used to calculate the first or second average value of distorted relative wind direction values as Equation (12). The variance value of the sum of the internal noises of the assembly angle and the flow deflection angle is approximated as a value close to 0 to calculate the first or second variance value of intermediate, distorted relative wind direction values.

μₘ_{_{k|k−1}}=μₘ_{_{k−1}}+ξₖ (12)

p_{k|k-1}=pₖ₋₁+q (13)

where μₘ_{_{k−1}} is the first or second average value of previous, distorted relative wind direction values, and μₘ_{_{k|k−1}} is the first or second average value of intermediate, distorted relative wind direction values, and pₖ₋₁ is the first or second variance value of previous, distorted relative wind direction values, and p_{k|k-1} is the first or second variance value of intermediate, distorted relative wind direction values, and q is a variance value of the sum of internal noises of the assembly angle and the flow deflection angle and is obtained via Kalman filter tuning for the Kalman filter (K^{φ+δ}) to calculate the summed values of assembly angles and flow deflection angles and for the Kalman filter (K^{φ}) to calculate assembly angles, respectively. The initial average and variance values of the first or second distorted relative wind direction values use the first or second average and variance values of really measured relative wind direction values, respectively.

In step S17, the first or second average and variance values of current, observed relative wind direction values are calculated as Equations (14) and (15).

μₒ_{ₖ}=h(μₘ_{_{k|k−1}})=α₁×μₘ_{_{k|k−1}}+α₂ (14)

sₖ=α₁²p_{k|k-1}+rₖ (15)

rₖ is a variance value of current sensor noise and is approximated by the first or second variance value of current, really measured relative wind direction values.

In step S18, a current Kalman gain is calculated as Equation (16) using Equations (13) and (15).

kₖ=p_{k|k-1}α₁sₖ⁻¹ (16)

In step 519, to calculate and store the first or second value of current, distorted relative wind direction values as Equation (17), the first or second average value (μₘ_{_{k|k−1}}) of intermediate, distorted relative wind direction values, the first or second average value (ξ_{z}_{ₖ}) of current, really measured relative wind direction values, a current Kalman gain (kₖ), and the first or second average value (μₒ_{ₖ}) of current, observed relative wind direction values are used. To calculate and store the first or second variance value of current, distorted relative wind directions as Equation (18), the current Kalman gain (kₖ) and the first or second variance value (p_{k|k-1}) of intermediate, distorted relative wind direction values are used.

μₘ_{ₖ}=μₘ_{_{k|k−1}}+kₖ(μ_{z}_{ₖ}−μₒ_{ₖ}) (17)

pₖ=(1−kₖα₁)p_{k|k-1} (18)

In step S20, the Kalman filtering is stopped or continued depending on whether or not the Kalman filtering continues.

Thus, a series of the sum values of assembly angles and flow deflection angles is calculated through the Kalman filter through steps S11 to S20 using the first average value of really measured relative wind direction values over T^{φ+δ} during which real relative wind directions are approximated as 0.

Also, using the second average value of really measured relative wind direction values over T^{φ} during which all average values of real relative wind directions and flow deflection angles are approximated as 0, only assembly angles are calculated through the Kalman filter through steps S11 to S20.

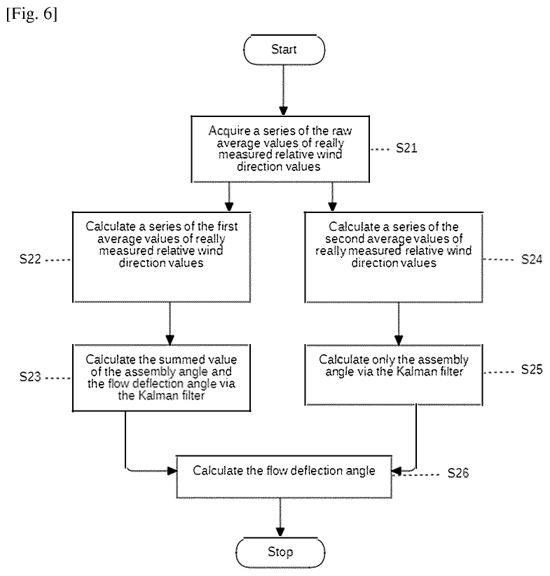

The procedure to calculate flow deflection angles via the Kalman filter is summarized as follows. As shown in FIG. 6, in step S21, a series of raw average values of really measured relative wind direction values is obtained. In step S22, a series of the first average values of really measured relative wind direction values is obtained. In step S23, summed values of assembly angles and flow deflection angles are calculated through the Kalman filter. In step S24, a series of the second average values of really measured relative wind direction values is obtained. In step 25, assembly angle values are only calculated via the Kalman filter. Finally, in step 26, flow deflection angles are calculated by subtracting assembly angles obtained in step S25 from the summed values of assembly angles and flow deflection angles obtained in step S26. In the case that raw average values (μ_{z}_{ₜ}^{raw}) of current, really measured relative wind direction values are used as an input factor of K^{φ}, current assembly angles (φₖ) and flow deflection angles (δₖ) with the period of T^{φ} are calculated where raw average values of really measured relative wind direction values are used as an input factor of K^{φ+δ} at R-1 intervals.

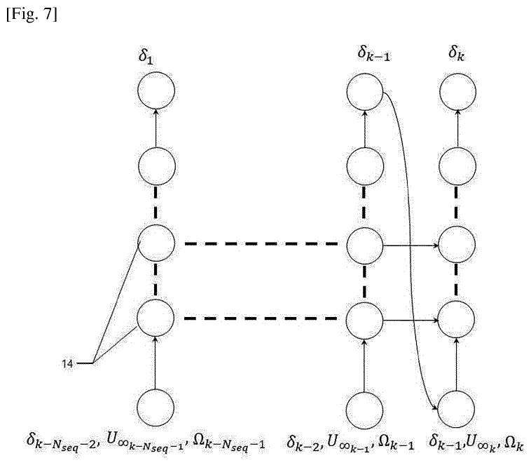

As shown in FIG. 7, the recurrent neural network based sequence flow deflection angle prediction model is created using current flow deflection angles (δₖ) as a target feature and using previous flow deflection angles (δₖ₋₁) and the second average values of current free wind speeds (U_{∞}_{ₖ}^{2nd}) and current rotor rotation speeds (Ωₖ^{2nd}) as input features. A series of flow deflection angle estimates obtained in step S26 and a series of the second average values of free wind speeds and rotor rotation speeds obtained from wind turbine operation data are used as training data to train the recurrent neural network based sequence flow deflection angle prediction model.

Flow deflection angles are estimated using the Kalman filter, which is a rule-based method, and a series of flow deflection angles estimated by this method are used as the target and input features of the recurrent neural network based sequence flow deflection angle prediction model that is a deep learning based method, and a more accurate flow deflection angle estimation nonlinear relationship model than the rule-based method is obtained.

As shown in [FIG. 7], to create the recurrent neural network based sequence flow deflection prediction model, The LSTM (Long Short-Term Memory) or LSTM variant is used as the recurrent unit layer of the recurrent neural network, and the layer length is determined for the prediction model to be optimized. Equation (19) is the recurrent neural network based sequence flow deflection angle prediction model's function using the LSTM or LSTM variant as the unit layer of the recurrent neural network.

\hat{δ}_{i,k-N}_{_{seq}}_{+1:k}=F(x_{i,k-N}_{_{seq}}_{+1:k},h_{i,0},c_{i,0};W^{rnn}) (19)

where \hat{δ}_{i,k-N}_{_{seq}}_{+1:k} is a sequence of target feature vectors composed of flow deflection angles from k−N_{seq}+1 to k for the ith batch, and N_{seq} is the number of the sequence of the recurrent neural network based flow deflection prediction model, x_{i,k-N}_{_{seq}}_{+1:k} is a sequence of input feature vectors composed of flow deflection angles from k−N_{seq} to k−1 and the second free wind speed and rotor rotation speed average values from k−N_{seq}+1 to k for the ith batch, and h is the h_{i,0} hidden internal state of the sequence for the ith batch, and c_{i,0} is the 0th cell internal state of the sequence for the ith batch, and W^{rnn} is the set of weight parameters for each function.

To train the parameters of each function of Equation (19) using training data, a loss function is defined as Equation (20).

$${L}_{RNN} = \frac{1}{{Λ}_{batch}^{RNN} \times {N}_{seq}} {\sum }_{i = 1}^{{N}_{batch}^{RNN}} {\sum }_{j = k + {N}_{seq} + 1}^{k} {( {\hat{δ}}_{i , j} - {δ}_{i , j} )}^{2} \qquad ( 20 )$$

where N_{batch}^{RNN} is the number of a batch, and δ_{i,j} is the jth ground truth of the sequence of the target feature.

By optimizing the loss function of Equation (20) by gradient descent, optimized weight data of the recurrent neural network based sequence flow deflection angle prediction model is obtained.

The optimized weight data is stored to be used as the actor weight data of the actor-critic based flow deflection angle prediction deep reinforcement learning model.

In step S3, after the self-learning yaw misalignment control intelligent entity (100) is installed in a wind turbine, the actor-critic based flow deflection angle prediction reinforcement learning module (19) is initialized by loading the pre-trained weight (20, W^{rnn}) of the recurrent neural network based sequence flow deflection prediction model as the actor weight data (W^{actor}), before the first wind turbine operation and then, is initialized through loading the pre-trained W^{rnn} into the actor or loading the actor weight data (W^{actor}) and critic weight data (W^{critic}) trained during the operation according to operators' choice, before a wind turbine's operation.

In step S4, after starting a wind turbine's operation, in the self-learning yaw misalignment control intelligent entity, the average values of current, really measured relative wind direction values (μ_{z}_{ₜ}^{raw}), current free wind speeds (U_{∞}_{ₜ}^{raw}), current output power values (Pₜ^{raw}), and current rotor rotation speeds (ωₜ^{raw}) which are averaged for T^{raw} are received from the wind vane, anemometer, output power sensor, and rotor rotation speed sensor (16). Then, as the flowchart of FIG. 5, the Kalman filter module (17) calculates current assembly angles (φₖ) with the T^{φ} period by using raw average values (μ_{z}_{ₜ}^{raw}) of current, really measured relative wind direction values as the input of K^{φ} which is the Kalman filter to calculate assembly angles, and with such the T^{φ} period, calculates the second average values of current, really measured relative wind direction values (μ_{z}_{ₖ}^{2nd}), current free wind speeds (U_{∞}_{ₖ}^{2nd}), current rotor rotation speeds (ωₖ^{2nd}), and current output power values (Pₖ^{2nd}).

The second average values of current free wind speeds (U_{∞}_{ₖ}^{2nd}), current rotor rotation speeds (Ωₖ^{2nd}), and current output power values (Pₖ^{2nd}) calculated in the Kalman filter module (17) are sent and stored to the experience replay buffer (18), and current assembly angles (φₖ) and current, really measured relative wind direction values' second average values are sent to the yaw misalignment calculation and calibration module (22).

The experience replay buffer (18) is a circular buffer to save Nₑₓₚ unit experience features where a unit experience feature is composed of a free wind speed (U_{∞}), a rotor rotation speed (Ω) a flow deflection angle (δ), and an output power value (P).

To predict current flow deflection angels (δₖ), in the initialized actor-critic based flow deflection angle prediction reinforcement learning module (19), a sequence of N_{seq} input unit features from previous input unit features to a current input unit feature as Equation (22) is sampled from the experience replay buffer (18) where the current input unit feature is defined as a current flow deflection angle, the second average values of current free wind speeds and rotor rotation speeds as Equation (21). Then, as Equation (23), via the actor (π), current flow deflection angles (δₖ) are predicted, and sent, and stored to the experience replay buffer (18) and sent to the yaw misalignment calculation and calibration module (22).

$${x}_{k} = 〈 {δ}_{k - 1} , {U}_{{∞}_{k}}^{2 nd} , {Ω}_{k}^{2 nd} 〉 \qquad ( 21 )$$

$${x}_{k - {N}_{seq} + 1 : k} = 〈 {δ}_{k - {N}_{seq} : k - 1} , {U}_{{∞}_{k - {N}_{seq} + 1 : k}}^{2 nd} , {Ω}_{k - {N}_{seq} + 1 : k}^{2 nd} 〉 \qquad ( 22 )$$

$${δ}_{k} = π ( {x}_{k - {N}_{seq} + 1 : k} , {h}_{0} , {c}_{0} ; {W}^{actor} ) \qquad ( 23 )$$

The actor-critic based flow deflection angle prediction reinforcement learning module (19) obtains batch-sequence (N_{batch}^{RL}×N_{seq}) training data with the period of T^{learn} from the experience replay buffer (18) via sampling current reinforcement learning unit feature N_{batch}^{RL} sequences as Equation (25) based on the reinforcement learning unit feature sequence of Equation (24).

$${τ}_{k - {N}_{seq} + 1 : k} = 〈 {U}_{{∞}_{k - {N}_{seq} + 1 : k}}^{2 nd} , {Ω}_{k - {N}_{seq} + 1 : k}^{2 nd} , {δ}_{k - {N}_{seq} : k - 1} , {P}_{k + 1}^{2 nd} , {U}_{{∞}_{k - {N}_{seq} + 2 : k + 1}}^{2 nd} , {Ω}_{k - {N}_{seq} + 2 : k + 1}^{2 nd} , {δ}_{k - {N}_{seq} + 1 : k} 〉 \qquad ( 24 )$$

$${τ}_{1 : {N}_{batch}^{RL} k - {N}_{seq} + 1 : k} = 〈 {U}_{{∞}_{1 : {N}_{batch}^{RL} , k - {N}_{seq} - 1 : k}}^{2 nd} , {Ω}_{1 : {N}_{batch}^{RL} , k - {N}_{seq} + 1 : k}^{2 nd} , {δ}_{1 : {N}_{batch}^{RL} , k - {N}_{seq} : k - 1} , {P}_{1 : {N}_{batch}^{RL} , k + 1}^{2 nd} , {U}_{{∞}_{1 : {N}_{batch}^{RL} , k - {N}_{seq} + 2 : k + 1}}^{2 nd} , {Ω}_{1 : {N}_{batch}^{RL} , k - {N}_{seq} + 2 : k + 1}^{2 nd} , {δ}_{1 : {N}_{batch}^{RL} , k - {N}_{seq} + 1 : k} 〉 \qquad ( 25 )$$

As shown in FIG. 9, the critic model is a recurrent neural network model with the recurrent neural network unit layer (15) of the LSTM or LSTM variant and is defined as Equation (26), as an action-value function of the reinforcement learning model having the input sequence of the recurrent neural network model as a current state sequence

$${s}_{k - {N}_{seq} - 1 : k}$$

and a current action (aₖ) as a factor affecting the output feature of the recurrent neural network, via using the state sequence

$${s}_{k - {N}_{seq} - 1 : k}$$

from previous states to a current state and the current action (aₖ) as the input. The current state (sₖ=<U_{∞}_{ₖ}, Ωₖ>) of the reinforcement learning model is defined with the current free wind speed (U_{∞}_{ₖ}) and the current rotor rotation speed (Ωₖ), and the current action (aₖ=δₖ) of the reinforcement learning model is defined as the current flow deflection angle (δₖ).

Q(aₖ,s_{k-N}_{_{seq}}_{+1:k},h₀,c₀;W^{critic}) (26)

where h₀ is the 0th hidden internal feature vector of the sequence, and c₀ is the 0th cell internal feature vector of the sequence. When training the actors and critic models of the actor-critic based flow deflection angle prediction reinforcement learning module (19) using batch-sequence training data, first, batch-sequence training data is randomly shuffled to obtain independence between the sequence data in the batch, and then randomly shuffled batch-sequence training data is created.

When training, to increase sample efficiency, the mini-batch number (N_{mini-batch}^{RL}) is used as a batch unit in the shuffled batch-sequence training data, and step-based iterative training is carried out with the integer step number (Rₛₜₑₚ^{RL}=N_{batch}^{RL}/N_{mini-batch}^{RL}, Rₛₜₑₚ^{RL}ϵN) greater than 0, and such the step-based iterative within epoch-based iterative learning is carried out with the epoch number (N_{epoch}^{RL}). In the epoch-based iterative training, training is carried out by obtaining different shuffled batch-sequence training data for each epoch as the batch-sequence training data.

When the step-based iterative training of an actor-critical model within the epoch-based iterative learning is carried out using shuffled batch-sequence training data, shuffled mini-batch-sequences are sampled to train critic and actor models iteratively.

The actor-critic based flow deflection angle prediction deep reinforcement learning model is a model to predict flow deflection angles for optimized yaw control adapting to a wind turbine's environment in real-time, receiving free wind speed and rotor rotation speed states relevant to a wind turbine's environment, and output power as a reward value, in real-time. The current return of this model is the differential return defined as Equation (27).

Gₖ=Rₖ₊₁−R̅+Rₖ₊₂−R̅+Rₖ₊₃−R̅+ . . . (27)

R̅ is an average reward value, and a current reward value (Rₖ) are the second average value (Pₖ^{2nd}) of current output power values. The differential return expectation value of Equation (27) for the current state sequence

$${s}_{k - {N}_{seq} - 1 : k}$$

and the current action (aₖ) is the action-value function (Q) of Equation (26).

Here, with a temporal difference training method, the action-value function (Q) of the critic model is trained by the gradient descent method via defining the critic model's loss function as the expected value of a squared advantage as Equation (31) where the advantage is defined as Equation (30) using the shuffled mini-batch training data for critic model training as Equation (29).

$${τ}_{1 : {N}_{mini ‐ batch}^{RL} , k - {N}_{seq} + 1 : k}^{shuffled ‐ critic} = 〈 {U}_{{∞}_{1 : {N}_{mini ‐ batch}^{RL} , k - {N}_{seq} + 1 : k}}^{2 nd} , {Ω}_{1 : {N}_{mini ‐ batch}^{RL} , k - {N}_{seq} + 1 : k}^{2 nd} , {P}_{1 : {N}_{mini ‐ batch} , k + 1}^{2 nd} , {U}_{{∞}_{1 : {N}_{mini ‐ batch} , k - {N}_{seq} + 2 : k + 1} ,}^{2 nd} {Ω}_{1 : {N}_{mini ‐ batch}^{RL} , k - {N}_{seq} + 2 : k + 1}^{2 nd} 〉 \qquad ( 29 )$$

$${A}_{i} = {R}_{i , k} - \overline{R} + Q ( {s}_{i , k - {N}_{seq} + 2 : k + 1} , {a}_{i , k + 1} , {h}_{0} , {c}_{0} ; {W}^{critic} ) - Q ( {s}_{i , k - {N}_{seq} + 1 : k} , {a}_{i , k} , {h}_{0} , {c}_{0} ; {W}^{critic} ) \qquad ( 30 )$$

$${L}_{critic} = \frac{1}{{N}_{mini ‐ batch}^{RL}} {\sum }_{i = 1}^{{N}_{mini ‐ batch}^{RL}} {( {A}_{i} )}^{2} \qquad ( 31 )$$

i is the index of the shuffled mini-batch, and the advantage of Equation (30) is the estimated error of the reward value, and the average reward value (R̅) is approximated via updating iteratively with the temporal difference method as Equation (32).

$$\overline{R} ← \overline{R} + η \frac{1}{{N}_{mini ‐ batch}^{RL}} {\sum }_{i = 1}^{{N}_{mini ‐ batch}^{RL}} ( {A}_{i} ) \qquad ( 32 )$$

η is an average reward value update coefficient, which is a real number greater than 0.

Also, using the shuffled mini-batch-sequence training data to train the actor model as Equation (33), the actor model is trained with the proximal policy optimization method by the gradient ascent method via defining a loss function where for the multiplication (rᵢ(W^{actor}) Aᵢ) of a probability ratio and the advantage (Aᵢ) as Equation (35), the actor model's loss function becomes a certain value using the probability ratio of a current actor model (π) over a previous actor model (π_{old}) as Equation (34) in the case that the advantage (Aᵢ) is greater than 0, and the probability ratio (rᵢ(W^{actor})) is equal to and more than 1+ε, or the advantage (Aᵢ) is less than 0, and the probability ratio (rᵢ(W^{actor})) is equal to and less than 1−ε. ε is a value greater than 0 and less than 1.

$${τ}_{1 : {N}_{mini ‐ batch}^{RL} , k - {N}_{seq} + 1 : k}^{shuffled ‐ actor} = 〈 {{U}_{∞}}_{1 : {N}_{mini ‐ batch}^{RL} , k - {N}_{seq} + 1 : k} , {Ω}_{1 : {N}_{mini ‐ batch}^{RL} , k - {N}_{seq} + 1 : k} , {δ}_{1 : {N}_{mini ‐ batch}^{RL} , k - {N}_{seq} : k - 1} , {P}_{1 : {N}_{mini ‐ batch}^{RL} , k + 1} , {U}_{{∞}_{1 : {N}_{mini ‐ batch}^{RL} , k - {N}_{seq} + 2 : k + 1}} , {Ω}_{1 : {N}_{mini ‐ batch}^{RL} , k - {N}_{seq} + 2 : k + 1} , {δ}_{1 : {N}_{mini ‐ batch}^{RL} , k - {N}_{seq} + 1 : k} 〉 \qquad ( 33 )$$

$${r}_{i} ( {W}^{actor} ) = \frac{π ( {a}_{i , k} \vert {s}_{i , k - {N}_{seq} + 1 : k} , {a}_{t , k - {N}_{seq} : k - 1} : {W}^{actor} )}{{π}_{old} ( {a}_{i , k} \vert {s}_{i , k - {N}_{seq} + 1 : k} , {a}_{i , k - {N}_{seq} : k - 1} : {W}_{old}^{actor} )} \qquad ( 34 )$$

$${L}_{actor} = \frac{1}{{N}_{mini ‐ batch}^{RL}} {\sum }_{i = 1}^{{N}_{mini ‐ batch}^{RL}} min ( {r}_{i} ( {W}^{actor} ) {A}_{i} , clip ( {r}_{i} ( {W}^{actor} ) , 1 - ε , 1 + ε ) {A}_{i} ) \qquad ( 35 )$$

The actor and critic models' weight data of the actor-critic flow deflection angle prediction deep reinforcement learning model are stored as actor-critic model weight data (21).

Finally, the yaw misalignment calculation and calibration module (22) calculates current yaw misalignment values (γₖ) as Equation (36) using current assembly angles (φₖ) and the second average values (μ_{z}_{ₖ}^{2nd}) of current, really measured relative wind direction values obtained from the Kalman filter module (17) and current flow deflection angles obtained from the actor-critic based flow deflection angle prediction reinforcement learning module (19). And estimated yaw misalignment values are sent to the yaw controller (23) to perform real-time yaw misalignment control.

γₖ=μ_{z}_{ₖ}^{2nd}+φₖ+δₖ (36)

### REFERENCE SIGNS LIST

1: Blade
2: Rotor
3: Nacelle
4: Yawing system
5: Yaw controller
6: Meteorological mast
7: Wind direction
8: Nacelle direction
9: Turbulence
10: North
11: Real wind direction
12: Nacelle direction
13: Yawing system axis
14, 15: Recurrent neural network unit layer of the LSTM or LSTM variant
16: Wind vane, anemometer, output power sensor, and rotor rotation speed sensor
17: Kalman filter module
18: Experience relay buffer
19: actor-critic based flow deflection angle prediction reinforcement learning module
20: Pre-trained weight of the recurrent neural network based sequence flow deflection prediction model
21: Trained actor-critic model weight data
22: Yaw misalignment calculation and calibration module
23: Yaw controller

### PATENT LITERATURE

[1] Korea registered patent 10-1800217, CORRECTION METHOD FOR YAW ALIGNMENT ERROR OF WIND TURBINE

### NON PATENT LITERATURE

[2] Determination of optimal wind turbine alignment into the wind and detection of alignment changes with SCADA data, 2018, by Niko Mittelmeier and Martin Khun

1. The Kalman filter and deep reinforcement learning based yaw misalignment control method of a wind turbine comprises:
The step to receive operation data including really measured relative wind direction values during the normal operation for each wind turbine in a wind farm, and generating raw data for training a flow deflection angle prediction model;
The step to obtain assembly angles and flow deflection angles by applying a Kalman filter to really measured relative wind direction values for each wind turbine;
Previous flow deflection angles, current free wind speeds, and current rotor rotation speeds are used as input features, and current flow deflection angles are used as a target feature, and training data with a certain number of sequences is generated. The step to generate weight data by training a recurrent neural network based sequence flow deflection angle prediction model using the training data;
The recurrent neural network based sequence flow deflection angle prediction model is used as an actor in an actor-critic deep reinforcement learning model, and a recurrent neural network based sequence relationship model of free wind speeds, rotor rotation speed, and flow deflection angles and differential action values is used as a critic. The step to generate an actor-critic flow deflection angle prediction deep reinforcement learning model using output power as a reward value;
The step to predict non-stationary flow deflection angles by loading the weight data of a pre-trained recurrent neural network based sequence flow deflection angle prediction model as the actor weight data of the actor-critic flow deflection angle prediction deep reinforcement learning model;
The step of estimating and calibrating yaw misalignment values by adding flow deflection angles predicted by the actor-critic flow deflection angle prediction deep learning model and assembly angles obtained by the Kalman filter, using really measured relative wind direction values.

2. The method of claim 1, wherein the operation data further includes free wind speed, output power, rotor rotation speed, and measurement time values.

3. The method of claim 1, wherein the obtaining step of the flow deflection angle comprises:
The step to obtain a series of the summed values of assembly angles and flow deflection angles by applying a Kalman filter to a series of really measured relative wind direction values for each wind turbine;
The step to obtain a series of assembly angles by applying a Kalman filter to a series of really measured relative wind direction values; And The step to obtain a series of flow deflection angles for each wind turbine by subtracting a series of assembly angles from a series of the summed values of assembly angles and flow deflection angles.

4. The method of claim 3, wherein
the step of obtaining the series of the summed values of assembly angles and flow deflection angles
includes the step to calculate the first average values by averaging a series of really measured relative wind direction values over the first average value time and apply the calculated first average values to a Kalman filter, and
the step of obtaining the series of assembly angles
includes the step to calculate the second average values by averaging a series of really measured relative wind direction values over the second average value time and apply the calculated second average values to a Kalman filter.

5. The step to receive measured relative wind direction values, free wind speeds, output power values, and rotor rotation speeds information from the wind vane, the anemometer, the output power sensor, and the rotor rotation speed sensor as an input signal;
The step to calculate assembly angles from measured relative wind direction values through a Kalman filter;
The average values of each of the really measured relative wind direction, free wind speed, rotor rotation speed, and output power over a certain period of time are calculated, and the really measured relative wind direction average value, free wind speed average value, rotor rotation speed average value, and output power average value are stored in the experience replay buffer (18); And
in the actor critic based flow deflection angle prediction deep reinforcement learning module (19), a previous flow deflection angle, a current free wind speed, a current rotor rotation speed, a current flow deflection angle, and a next output power value stored to the experience replay buffer (18) are used as an unit experience value feature, and a series of experience value feature sequences is randomly sampled to generate training data, and actors and critic models are trained, and the trained weight data (21) of the actors and critic models is stored, and after training, current flow deflection angles are predicted using the sequence data of previous flow deflection angles, current free wind speeds, and current rotor rotation speeds for a certain period of time; And
yaw misalignment calibration values are calculated using current, measured relative wind direction average values, assembly angles, and flow deflection angles in the yaw misalignment calibration module (22), and the yaw misalignment calibration information is transmitted to the yaw controller (23). And
the yaw misalignment is calibrated in real-time by the yaw controller using the yaw misalignment calibration information.
